(19) United States
(12) Patent Application Publication
(10) Pub. No.: US 2025/0138265 A1
(43) Pub. Date: May 1, 2025

(54) OPTOELECTRONIC TRANSDUCER AND OPTICAL FIBER TRANSCEIVER MODULE USING THE SAME

(71) Applicant: TSO HAN CHIEN, NEW TAIPEI CITY (TW)

(72) Inventor: TSO HAN CHIEN, NEW TAIPEI CITY (TW)

(21) Appl. No.: 18/926,816

(22) Filed: Oct. 25, 2024

(30) Foreign Application Priority Data
Oct. 30, 2023 (TW) 112141555

(51) Int. Cl. G02B 6/42; G02B 6/43

(52) U.S. Cl. CPC G02B 6/4292; G02B 6/4204; G02B 6/43

(57) ABSTRACT

An optoelectronic transducer includes an enclosure provided with an optical transceiver port allowing a forward light beam and a backward light beam to pass therethrough and at least one electrical transceiver port; an optical module consisting of a plurality of optical elements that are pervious to light and can respectively reflect a specific one of many lights of different wavelengths; and an optoelectronic module consisting of at least one optical-electrical conversion element and at least one electro-optical conversion element, which are electrically connected to the electrical transceiver port. The optoelectronic module works with the optical module to converge multiple electrical signals to a single light beams. Two corresponding optoelectronic transducers can be connected via an optical fiber cable to form an optical fiber transceiver module for transmitting multiple electrical signals via the optical fiber cable.

### FIELD OF THE INVENTION

The present invention relates to an optoelectronic transducer, and more particularly, to an optoelectronic transducer capable of converting and integrating a plurality of electrical signals into a single light beam. The present invention also relates to an optical fiber transceiver module that uses one optical fiber connected to between two optoelectronic transducers to transmit the light beam.

### BACKGROUND OF THE INVENTION

Light beams or optical signals are often used in the transmission of digital data between adjacent circuit boards or between two long-distance apart electronic devices, and the light beam for data transmission can be modulated according to actual need.

Taiwan Invention Patent No. TW 1579611 discloses a typical optoelectronic transducer unit, which includes an optoelectronic transducer module, a printed circuit board (PCB) for coupling with the optoelectronic transducer module, a plurality of wires for coupling with the PCB, an optical fiber element having a plurality of optical fibers for transmitting optical signals, an optical ferrule for holding the optoelectronic transducer module and the optical fiber element together, and a connector being electrically connected to the PCB.

The above mentioned optoelectronic transducer module includes a carrier, at least one optical element arranged on the carrier, an optical platform having a first zone for supporting the PCB thereon, a second zone for supporting the carrier thereon, a first lens array arranged below the carrier to align with the at least one optical element, a mirror arranged below the first lens array, and a second lens array arranged to a left side of the mirror. These components are securely located for stable transmission of optical and electrical signals.

However, in the above structure, lenses in the first and the second lens arrays are designed to transmit (or reflect) one single optical signal in only one direction. Therefore, an optical and electrical hybrid cable connected to between two corresponding optoelectronic transducer units must include a plurality of optical fibers and a plurality of electrical conductors. This design is obviously non-economical and is easily subjected to electrical signal attenuation when being applied to transmit signals over a relatively long distance.

In view of the conventional optoelectronic transducer unit has the above described disadvantages in practical application thereof, it is therefore tried by the inventor to overcome the disadvantages in the prior art by developing an optoelectronic transducer and an optical fiber transceiver module using the same.

### SUMMARY OF THE INVENTION

A primary object of the present invention is to provide an optoelectronic transducer, which includes an enclosure, an optical module, and an optoelectronic module. The enclosure internally defines a receiving space and is provided with an optical transceiver port and at least one electrical transceiver port; the optical transceiver port allows a forward light beam to pass therethrough into the receiving space and also allows a backward light beam of the forward light beam to pass therethrough from the receiving space and be transmitted outward. The optical module consists of a plurality of optical elements that are pervious to light. The optical elements are obliquely disposed in the receiving space and are spaced along a path of the forward light beam and of the backward light beam. The optical elements can respectively reflect a specific one of many lights of different wavelengths. The optoelectronic module consists of at least one optical-electrical conversion element and at least one electro-optical conversion element, which are electrically connected to the electrical transceiver port. The optical-electrical conversion elements are disposed at paths along which the forward light beam is reflected from the optical elements, and the electro-optical conversion elements are disposed at paths along which lights can be projected to the optical elements to be converged into the backward light beam. In the process of penetrating the optical elements, the forward light beam is reflected and dissociated by the optical elements into multiple fixed-wavelength forward lights having different wavelengths, which are received by the optical-electrical conversion elements to be converted to different electrical signals and transmitted outward via the electrical transceiver port. The electro-optical conversion elements receive different electrical signals via the electrical transceiver port to generate fixed-wavelength backward lights having different wavelengths, which are reflected by corresponding ones of the optical elements and converged into the backward light beam to be transmitted outward via the optical transceiver port. With these arrangements, an optoelectronic transducer is formed for converting and integrating multiple electrical signals and one single light beam.

Another object of the present invention is to provide an optical fiber transceiver module using the above optoelectronic transducer. An optoelectronic transducer and a corresponding optoelectronic transducer are connected via an optical fiber cable to form the optical fiber transceiver module. The corresponding optoelectronic transducer includes a corresponding optoelectronic module, which includes corresponding optical-electrical conversion elements corresponding to the electro-optical conversion elements in the optoelectronic transducer and corresponding electro-optical conversion elements corresponding to the optical-electrical conversion elements. By using the optoelectronic module and the corresponding optoelectronic module to convert electrical signals and light beam and using the optical fiber cable to transmit the light beam, it is able to achieve the effect of transmitting multiple electrical signals with only one optical fiber cable and effectively reduce the attenuation of electrical signal transmitted over long distance while enables upgraded overall cost-effectiveness.

The structure and the technical means adopted by the present invention to achieve the above and other objects can be best understood by referring to the following detailed description of the preferred embodiment and the accompanying drawings.

### BRIEF DESCRIPTION OF THE DRAWINGS

### Wherein:

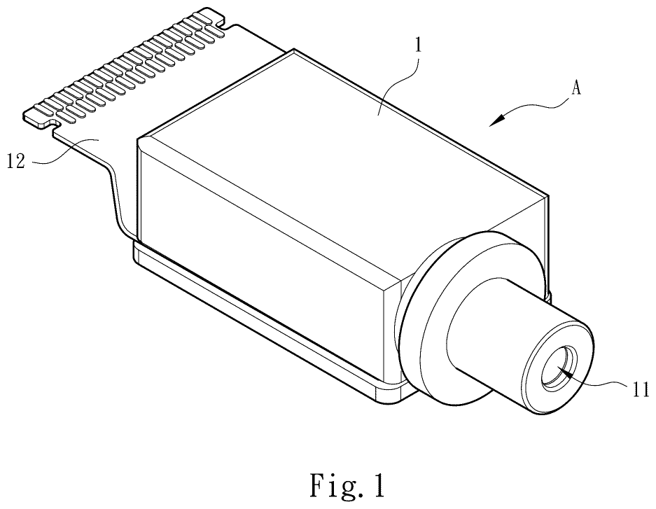

FIG. 1 is a perspective view of an optoelectronic transducer according to a preferred embodiment of the present invention;

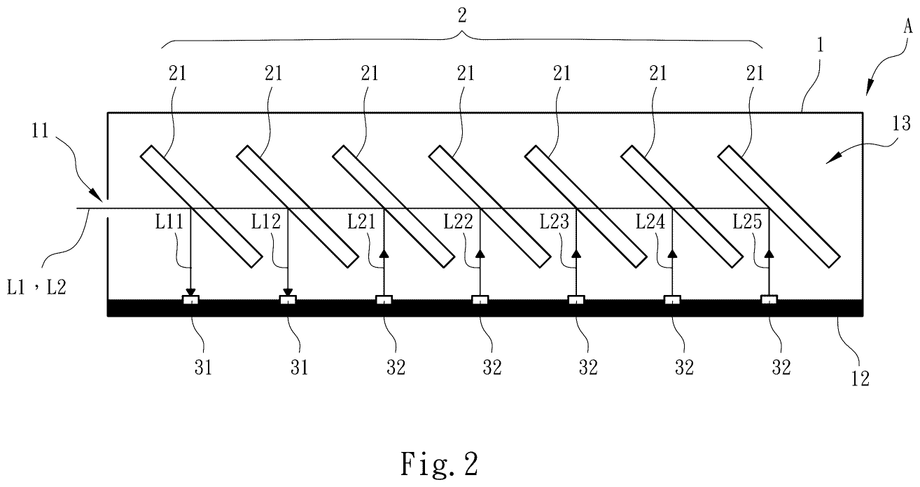

FIG. 2 shows the arrangement of an optical module and an optoelectronic module in an enclosure of the optoelectronic transducer of FIG. 1;

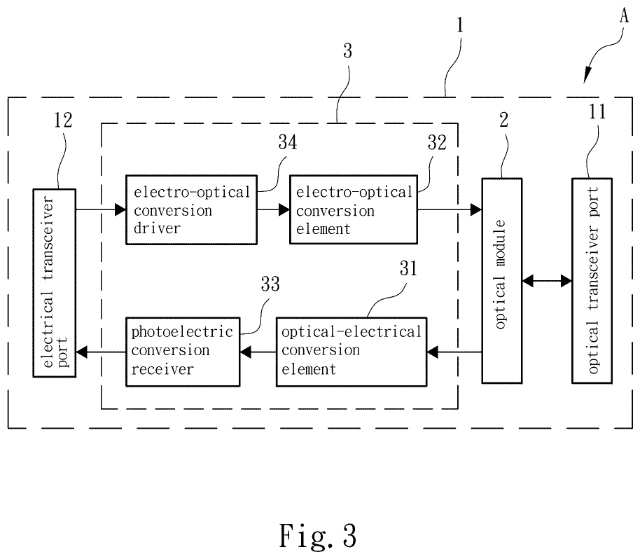

FIG. 3 is a block diagram of the optoelectronic transducer of the present invention;

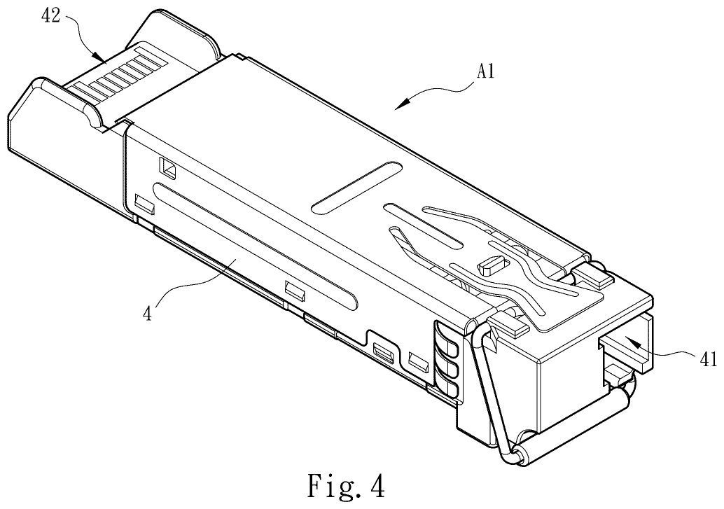

FIG. 4 is a perspective view of an optoelectronic pluggable module for the optoelectronic transducer of the present invention;

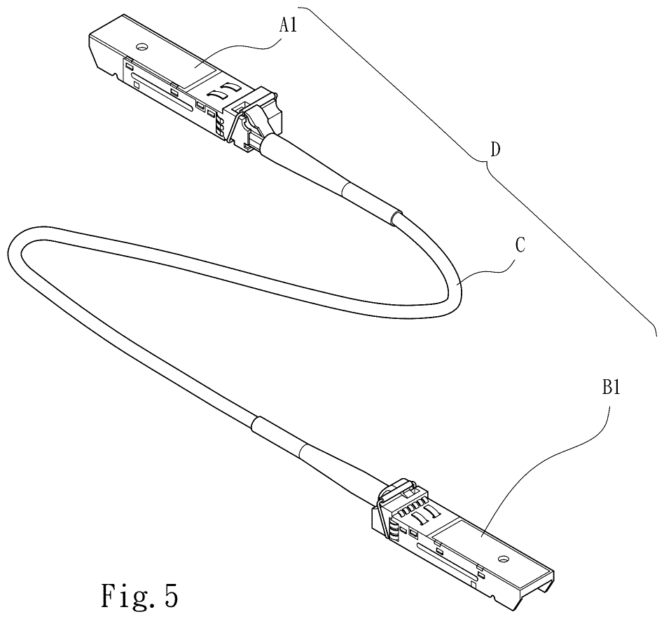

FIG. 5 is a perspective view of an optical fiber transceiver module according to the present invention;

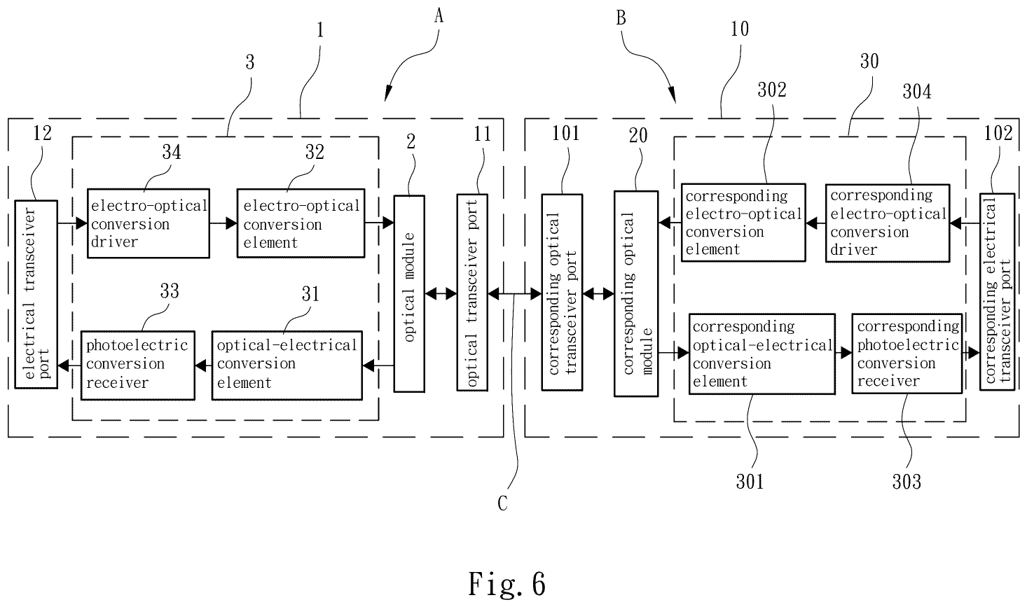

FIG. 6 is a block diagram of the optical fiber transceiver module of FIG. 5; and

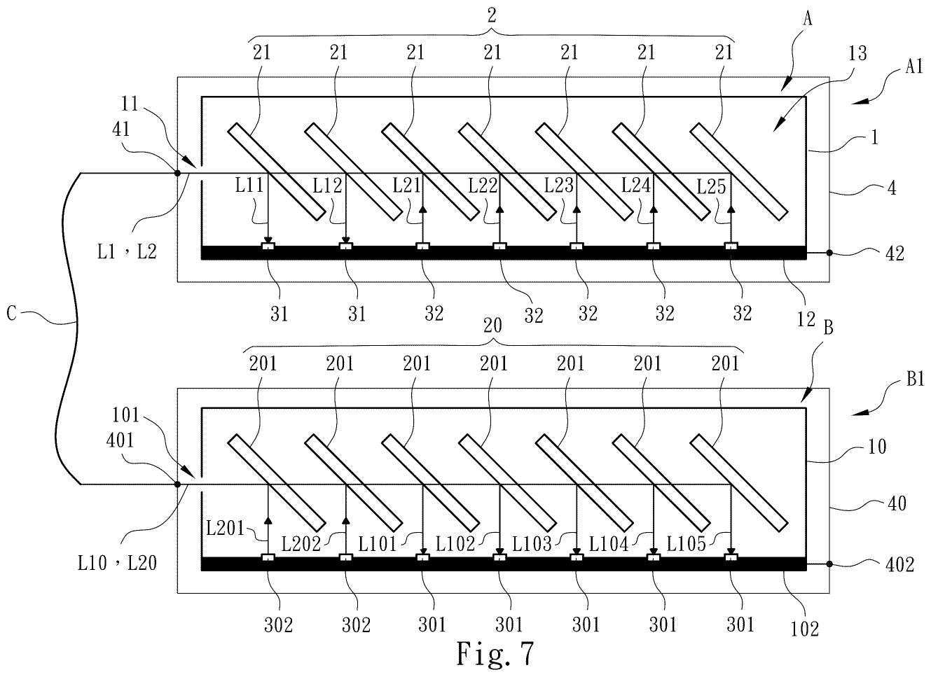

FIG. 7 shows the arrangement of an optical module and an optoelectronic module in an enclosure and a corresponding optical module and a corresponding optoelectronic module in a corresponding enclosure of the optical fiber transceiver module according to the present invention.

### DETAILED DESCRIPTION OF THE PREFERRED EMBODIMENTS

Please refer to FIGS. 1 to 3. An optoelectronic transducer A according to a preferred embodiment of the present invention includes an enclosure 1, an optical module 2, and an optoelectronic module 3. The enclosure 1 internally defines a receiving space 13 and is provided with an optical transceiver port 11 and at least one electrical transceiver port 12. The optical transceiver port 11 allows an external forward light beam L1 to pass therethrough into the receiving space 13, and also allows a backward light beam L2 (that is directionally opposite to the forward light beam L1) in the receiving space 13 to pass therethrough and be transmitted outward.

The optical module 2 consists of a plurality of optical elements 21 that are pervious to light. The optical elements 21 are positioned and spaced in the receiving space 13, for example, at an angle of 45 degrees relative to a path of the forward light beam L1 and the backward light beam L2. And, the optical elements 21 can respectively reflect a specific one of many lights of different wavelengths.

According to the embodiment shown in FIG. 2, when a forward light beam L1 passes through the optical transceiver port 11 into the receiving space 13, the light beam L1 sequentially passes through the optical elements 21. And, in the process the forward light beam L1 passes through the optical elements 21, the forward light beam L1 is reflected and dissociated by different ones of these optical elements 21 into multiple fixed-wavelength forward lights L11, L12 that are different in wavelength. Some the optical elements 21 of the optical module 2 reflect and dissociate the forward light beam L1 into a plurality of fixed-wavelength forward lights L11, L12 having different wavelengths, while other optical elements 21 reflect and integrate multiple fixed-wavelength backward lights L21˜L25 having different wavelengths into the backward light beam L2. Further, the number of the fixed-wavelength forward lights L11, L12 and of the fixed-wavelength backward lights L21˜L25 are adjustable according to different requirements.

In an operable embodiment, the fixed-wavelength forward lights L11, L12 and the fixed-wavelength backward lights L21˜L25 respectively have a fixed wavelength, for example, a wavelength of 970 nanometers (nm) or a wavelength of 1000 nm, to avoid the wavelengths that are frequently used by general optoelectronic transducers and accordingly, are distinguishable from other signals. However, in other operable embodiments, the fixed-wavelength forward lights L11, L12 and the fixed-wavelength backward lights L21˜L25 may otherwise have a length of 820 nm, 850 nm, 880 nm, 910 nm, or 940 nm without being particularly limited in the present invention.

The optoelectronic module 3 consists of a plurality of optical-electrical conversion elements 31, a plurality of electro-optical conversion elements 32, a photoelectric conversion receiver 33 electrically connected to the optical-electrical conversion elements 31, and an electro-optical conversion driver 34 electrically connected to the electro-optical conversion elements 32. The optical-electrical conversion elements 31 and the electro-optical conversion elements 32 all are electrically connected to the electrical transceiver port 12. The optical-electrical conversion elements 31 may be photodiodes and are correspondingly disposed on paths, along which the fixed-wavelength forward lights L11, L12 reflected and dissociated from the forward light beam L1 are projected, for receiving lights and converting the received lights into electrical signals. The photoelectric conversion receiver 33 can receive and integrate the electrical signals transmitted by the optical-electrical conversion elements 31 and output the integrated electrical signal via the electrical transceiver port 12.

The electro-optical conversion elements 32 may be laser diodes (LD) or light-emitting diodes (LED) and are disposed on paths along which the fixed-wavelength backward lights L21˜L25 to be integrated into the backward light beam L2 are projected. The electro-optical conversion driver 34 may be one of a laser diode (LD) driving chip, a light-emitting diode (LED) driving chip, and a transimpedance amplifier (TIA) for receiving the electrical signals input via the electrical transceiver port 12 and following the electrical signals to control the electro-optical conversion elements 32 to generate lights.

In the embodiment shown in FIG. 3, the optoelectronic module 3 of the optoelectronic transducer A has two optical-electrical conversion elements 31 and five electro-optical conversion elements 32 to match the number of the fixed-wavelength forward lights L11, L12 and of the fixed-wavelength backward lights L21˜L25, respectively. However, it is understood the optical-electrical conversion elements 31 and of the electro-optical conversion elements 32 in the present invention are not necessarily limited to the above mentioned quantity. The two optical-electrical conversion elements 31 (i.e. photodiodes) receive the fixed-wavelength forward lights L11, L12, respectively, and convert the received lights into different electrical signals. The converted electrical signals are integrated by the photoelectric conversion receiver 33 and then transmitted outward via the electrical transceiver port 12.

On the other hand, the electro-optical conversion driver 34 receives different external electrical signals via the electrical transceiver port 12 and drives the electro-optical conversion elements 32 to generate fixed-wavelength backward lights L21˜L25 that have different wavelengths. The fixed-wavelength backward lights L21˜L25 are reflected by corresponding optical elements 21 and converged to one single backward light beam L2, which is then transmitted outward via the optical transceiver port 11.

Please refer to FIGS. 4 to 7. The optoelectronic transducer A can be connected to a corresponding optoelectronic transducer B via an optical fiber C to form an optical fiber transceiver module D. The corresponding optoelectronic transducer B includes a corresponding enclosure 10, a corresponding optical module 20, and a corresponding optoelectronic module 30. The corresponding enclosure 10 is provided with a corresponding optical transceiver port 101 and at least one corresponding electrical transceiver port 102. The corresponding optical module 20 consists of a plurality of corresponding optical elements 201 that are similar to the optical elements 21. The corresponding optoelectronic module 30 includes a plurality of corresponding optical-electrical conversion elements 301 (such as optical diodes) that are corresponding to the electro-optical conversion elements 32 and a plurality of corresponding electro-optical conversion elements 302 (such as laser diodes or light-emitting diodes) that are corresponding to the optical-electrical conversion elements 31. The corresponding optical-electrical conversion elements 301 are electrically connected to a corresponding photoelectric conversion receiver 303, and the corresponding electro-optical conversion elements 302 are electrically connected to a corresponding electro-optical conversion driver 304.

The corresponding enclosure 10, the corresponding optical module 20, and the corresponding optoelectronic module 30 of the corresponding optoelectronic transducer B are assembled to each other in the same manner as the enclosure 1, the optical module 2, and the optoelectronic module 3 of the optoelectronic transducer A are assembled to each other, it is therefore not repeatedly described herein.

In practical application of the present invention, the optoelectronic transducer A is enclosed in an outer cover 4, which is provided on an outer side with an optical channel 41 corresponding to the optical transceiver port 11 and an interface port 42 electrically connected to the electrical transceiver port 12 for conveniently connecting with a default transmission end device (or a default receiving end device), so as to form an optoelectronic pluggable module A1; and the corresponding optoelectronic transducer B is enclosed in a corresponding outer cover 40, which is provided with a corresponding optical channel 401 corresponding to the corresponding optical transceiver port 101 and a corresponding interface port 402 electrically connected to the corresponding electrical transceiver port 102 for conveniently connecting with a default receiving end device (or a default transmission end device), so as to form a corresponding optoelectronic pluggable module B1.

The above described transmission end device and receiving end device can be a computing device, such as a personal computer, an industrial computer or a server, or an audio and video device, such as a speaker, a display screen, or a game console; and the interface port 42 and the corresponding interface port 402 (and the electrical transceiver port 12 and the corresponding electrical transceiver port 102) can be a high definition multimedia interface (HDMI), a display port (DP) interface, an embedded display port (eDP) interface, a peripheral component interconnect express (PCI-E) interface, a serial digital interface (SDI), a universal serial bus (USB) interface, a CoaXPress (CXP) interface, an optical copper link (OCulink) interface, or a mobile industry processor interface (MIPI), without being particularly limited to any specific type of interface in the present invention.

To use the optical fiber transceiver module D of the present invention, first plug two ends of the optical fiber cable C into the optical channel 41 of the optoelectronic pluggable module A1 and the corresponding optical channel 401 of the corresponding optoelectronic pluggable module B1, so that the optical fiber cable C is connected to between the optical transceiver port 11 of the optoelectronic transducer A and the corresponding optical transceiver port 101 of the corresponding optoelectronic transducer B.

In the case the interface port 42 of the optoelectronic pluggable module A1 is connected to a transmission end device (or a receiving end device) and the corresponding interface port 402 of the corresponding optoelectronic pluggable module B1 is connected to a receiving end device (or a transmission end device), and when the interface port 42 receives electrical signals via the transmission end device or the receiving end device, the electrical signals can be imported to the electro-optical conversion driver 34 via the electrical transceiver port 12 of the optoelectronic transducer A. The electro-optical conversion driver 34 can follow the electrical signal instructions to drive the electro-optical conversion elements 32 to generate fixed-wavelength backward lights L21˜L25 that have different wavelengths. The fixed-wavelength backward lights L21˜L25 are respectively reflected by the corresponding one of the optical elements 21 and then converged to the one single backward light beam L2, which passes through the optical transceiver port 11 and the optical channel 41 sequentially to be imported to the optical fiber cable C. After passing through the optical fiber cable C, the backward light beam L2 is imported to the corresponding optoelectronic pluggable module B1 via the corresponding optical channel 401 and the corresponding optical transceiver port 101 to form a corresponding forward light beam L10 that enters the corresponding optoelectronic transducer B. The corresponding forward light beam L10 can penetrate the corresponding optical elements 201 to be reflected and dissociated into multiple corresponding fixed-wavelength forward lights L101˜L105 that have different wavelengths. The corresponding fixed-wavelength forward lights L101˜L105 are then received by the corresponding optical-electrical conversion elements (or optical diodes) 301, respectively, to be converted into different electrical signals, which pass through the corresponding electrical transceiver port 102 and the corresponding interface port 402 sequentially and are outward transmitted to the receiving end device (or the transmission end device).

On the other hand, when the corresponding interface port 402 receives electrical signals from the receiving end device (or the transmission end device), the electrical signals can be imported to the corresponding electro-optical conversion driver 304 via the corresponding electrical transceiver port 102 of the corresponding optoelectronic transducer B. The corresponding electro-optical conversion driver 304 can follow the electrical signal instructions to drive the corresponding electro-optical conversion elements 302 to generate corresponding fixed-wavelength backward lights L201, L202 that have different wavelengths. The corresponding fixed-wavelength backward lights L201, L202 are respectively reflected by the corresponding one of the corresponding optical elements 201 and then converged to the one single corresponding backward light beam L20, which passes through the corresponding optical transceiver port 101 and the corresponding optical channel 401 sequentially and is imported to the optical fiber cable C. After passing through the optical fiber cable C, the backward light beam L20 can be imported to the optoelectronic pluggable module A1 via the optical channel 41 and then passes through the optical transceiver port 11 to form the forward light beam L1 that enters the optoelectronic transducer A. The forward light beam L1 can penetrate the optical elements 21 and are reflected and dissociated into multiple fixed-wavelength forward lights L11, L12 that have different wavelengths. The fixed-wavelength forward lights L11, L12 are then received by the optical-electrical conversion elements or optical diodes 31 and converted into different electrical signals, which pass through the electrical transceiver port 12 and the interface port 42 sequentially to be outward transmitted to the transmission end device or the receiving end device. With the above described optoelectronic transducer and the optical fiber transceiver module of the present invention, a plurality of electrical signals can be converted and transmitted via one single optical fiber cable. The application of the present invention can fully correspond to the signal quantity at the device end, and has the advantages of being small in volume, having simple optical path, and so on.

According to the above discussion, the optoelectronic transducer and the optical fiber transceiver module of the present invention have the advantages of enabling integration and conversion of multiple electrical signals and one single light beam and using one single optical fiber cable to transmit the light beam. Therefore, the present invention meets the requirements of novelty and improvement for granting a patent. It is also understood the present invention has been described with a preferred embodiment thereof and it is understood that many changes and modifications in the described embodiment can be carried out without departing from the scope and the spirit of the invention that is intended to be limited only by the appended claims.

What is claimed is:

1. An optoelectronic transducer (A) comprising an enclosure (1), an optical module (2), and an optoelectronic module (3);
the enclosure (1) internally defining a receiving space (13) and being provided with an optical transceiver port (11) and at least one electrical transceiver port (12); the optical transceiver port (11) allowing an external forward light beam (L1) to pass therethrough into the receiving space (13) and also allowing a backward light beam (L2) in the receiving space (13) to pass therethrough to be transmitted outward;
the optical module (2) consisting of a plurality of optical elements (21) that are pervious to light; the optical elements (21) being positioned in the receiving space (13) to space from each other along a path of the forward light beam (L1) and the backward light beam (L2); some of the optical elements (21) reflecting and dissociating the forward light beam (L1) into a plurality of fixed-wavelength forward lights of different wavelengths (L11, L12), while other optical elements (21) reflecting and converging a plurality of fixed-wavelength backward lights of different wavelengths (L21˜L25) from the optoelectronic module (3) to the backward light beam (L2); and
the optoelectronic module (3) consisting of a plurality of optical-electrical conversion elements (31) and a plurality of electro-optical conversion elements (32) all being electrically connected to the electrical transceiver port (12); the optical-electrical conversion elements (31) being correspondingly disposed on paths along which the fixed-wavelength forward lights (L11, L12) are projected, and the electro-optical conversion elements (32) being disposed on paths along which the fixed-wavelength backward lights (L21˜L25) can be projected, such that the forward light beam (L1) can be reflected and dissociated by the optical elements (21) into the plurality of fixed-wavelength forward lights of different wavelengths (L11, L12); the fixed-wavelength forward lights of different wavelengths (L11, L12) being received by the optical-electrical conversion elements (31) and then converted to different electrical signals to be transmitted outward via the electrical transceiver port (12); and the electro-optical conversion elements (32) allowing for receiving of different electrical signals from the electrical transceiver port (12), the received electrical signals being converted to generate the fixed-wavelength backward lights (L21˜L25), which are reflected and converged by corresponding optical elements (21) to the backward light beam (L2).

2. The optoelectronic transducer as claimed in claim 1, further comprising an electro-optical conversion driver (34) provided between the electro-optical conversion elements (32) and the electrical transceiver port (12) and a photoelectric conversion receiver (33) provided between the optical-electrical conversion elements (31) and the electrical transceiver port (12); the electro-optical conversion driver (34) receiving electrical signals input via the electrical transceiver port (12) and following the electrical signals to correspondingly control the electro-optical conversion elements (32) to operate; and the photoelectric conversion receiver (33) receiving electrical signals converted and transmitted by the optical-electrical conversion elements (31) and outward transmitting the electrical signals via the electrical transceiver port (12).

3. The optoelectronic transducer as claimed in claim 1, wherein the optical elements (21) are positioned obliquely in the receiving space to space from each other along the path of the forward light beam (L1) and the backward light beam (L2).

4. The optoelectronic transducer as claimed in claim 1, wherein the fixed-wavelength forward lights (L11, L12) have a wavelength of at least one of 970 nm and 1000 nm.

5. The optoelectronic transducer as claimed in claim 2, wherein the fixed-wavelength forward lights (L11, L12) have a wavelength of at least one of 970 nm and 1000 nm.

6. The optoelectronic transducer as claimed in claim 1, wherein the fixed-wavelength backward lights (L21˜L25) have a wavelength of at least one of 970 nm and 1000 nm.

7. The optoelectronic transducer as claimed in claim 2, wherein the fixed-wavelength backward lights (L21˜L25) have a wavelength of at least one of 970 nm and 1000 nm.

8. The optoelectronic transducer as claimed in claim 1, wherein the electrical transceiver port (12) is selected from the group consisting of a high definition multimedia interface (HDMI), a display port (DP) interface, a peripheral component interconnect express (PCI-E) interface, a serial digital interface (SDI), a universal serial bus (USB) interface, a CoaXPress (CXP) interface, an optical copper link (OCulink) interface, and a mobile industry processor interface (MIPI).

9. The optoelectronic transducer as claimed in claim 2, wherein the electrical transceiver port (12) is selected from the group consisting of a high definition multimedia interface (HDMI), a display port (DP) interface, a peripheral component interconnect express (PCI-E) interface, a serial digital interface (SDI), a universal serial bus (USB) interface, a CoaXPress (CXP) interface, an optical copper link (OCulink) interface, and a mobile industry processor interface (MIPI).

10. The optoelectronic transducer as claimed in claim 4, wherein the electrical transceiver port (12) is selected from the group consisting of a high definition multimedia interface (HDMI), a display port (DP) interface, a peripheral component interconnect express (PCI-E) interface, a serial digital interface (SDI), a universal serial bus (USB) interface, a CoaXPress (CXP) interface, an optical copper link (OCulink) interface, and a mobile industry processor interface (MIPI).

11. The optoelectronic transducer as claimed in claim 6, wherein the electrical transceiver port (12) is selected from the group consisting of a high definition multimedia interface (HDMI), a display port (DP) interface, a peripheral component interconnect express (PCI-E) interface, a serial digital interface (SDI), a universal serial bus (USB) interface, a CoaXPress (CXP) interface, an optical copper link (OCulink) interface, and a mobile industry processor interface (MIPI).

12. The optoelectronic transducer as claimed in claim 1, wherein the optical-electrical conversion elements (31) are optical diodes, and the electro-optical conversion elements (32) are laser diodes.

13. The optoelectronic transducer as claimed in claim 2, wherein the optical-electrical conversion elements (31) are optical diodes, and the electro-optical conversion elements (32) are laser diodes.

14. An optical fiber transceiver module employing the optoelectronic transducer as claimed in claim 1, comprising the optoelectronic transducer (A), a corresponding optoelectronic transducer (B), and an optical fiber cable (C);
the corresponding optoelectronic transducer (B) including a corresponding enclosure (10), a corresponding optical module (20), and a corresponding optoelectronic module (30); the corresponding enclosure (10) being provided with a corresponding optical transceiver port (101) and a corresponding electrical transceiver port (102), and the optical fiber cable (C) being connected to between the optical transceiver port (11) and the corresponding optical transceiver port (101); and the corresponding optical transceiver port (101) allowing a corresponding forward light beam (L10) and a corresponding backward light beam (L20) to pass therethrough;
the corresponding optical module (20) consisting of a plurality of corresponding optical elements (201), which are disposed in the corresponding enclosure (10) on a path along which the corresponding forward light beam (L10) and the corresponding backward light beam (L20) are projected; some of the corresponding optical elements (201) reflecting and dissociating the corresponding forward light beam (L10) into a plurality of corresponding fixed-wavelength forward lights of different wavelengths (L101˜L105), while other corresponding optical elements (201) reflecting a plurality of corresponding fixed-wavelength backward lights having different wavelengths (L201, L202) from the corresponding optoelectronic module (30) and converging the corresponding fixed-wavelength backward lights of different wavelengths (L201, L202) into the corresponding backward light beam (L20); and
the corresponding optoelectronic module (30) consisting of corresponding optical-electrical conversion elements (301) that are corresponding to the electro-optical conversion elements (32), and corresponding electro-optical conversion elements (302) that are corresponding to the optical-electrical conversion elements (31); the corresponding optical-electrical conversion elements (301) being disposed on a path along which the corresponding fixed-wavelength forward lights (L101˜L105) are projected, and the corresponding electro-optical conversion elements (302) being disposed on a path along which the corresponding fixed-wavelength backward lights (L201, L201) can be projected.

15. An optical fiber transceiver module employing the optoelectronic transducer as claimed in claim 2, comprising the optoelectronic transducer (A), a corresponding optoelectronic transducer (B), and an optical fiber cable (C);
the corresponding optoelectronic transducer (B) including a corresponding enclosure (10), a corresponding optical module (20), and a corresponding optoelectronic module (30); the corresponding enclosure (10) being provided with a corresponding optical transceiver port (101) and a corresponding electrical transceiver port (102), and the optical fiber cable (C) being connected to between the optical transceiver port (11) and the corresponding optical transceiver port (101); and the corresponding optical transceiver port (101) allowing a corresponding forward light beam (L10) and a corresponding backward light beam (L20) to pass therethrough;
the corresponding optical module (20) consisting of a plurality of corresponding optical elements (201), which are disposed in the corresponding enclosure (10) on a path along which the corresponding forward light beam (L10) and the corresponding backward light beam (L20) are projected; some of the corresponding optical elements (201) reflecting and dissociating the corresponding forward light beam (L10) into a plurality of corresponding fixed-wavelength forward lights of different wavelengths (L101˜L105), while other corresponding optical elements (201) reflecting a plurality of corresponding fixed-wavelength backward lights having different wavelengths (L201, L202) from the corresponding optoelectronic module (30) and converging the corresponding fixed-wavelength backward lights of different wavelengths (L201, L202) into the corresponding backward light beam (L20); and
the corresponding optoelectronic module (30) consisting of corresponding optical-electrical conversion elements (301) that are corresponding to the electro-optical conversion elements (32), and corresponding electro-optical conversion elements (302) that are corresponding to the optical-electrical conversion elements (31); the corresponding optical-electrical conversion elements (301) being disposed on a path along which the corresponding fixed-wavelength forward lights (L101˜L105) are projected, and the corresponding electro-optical conversion elements (302) being disposed on a path along which the corresponding fixed-wavelength backward lights (L201, L201) can be projected.

16. The optical fiber transceiver module as claimed in claim 14, wherein the optoelectronic transducer (A) is enclosed in an outer cover (4), which is provided on an outer side with an optical channel (41) corresponding to the optical transceiver port (11) and an interface port (42) electrically connected to the electrical transceiver port (12), to form an optoelectronic pluggable module (A1); the corresponding optoelectronic transducer (B) being enclosed in a corresponding outer cover (40), which is provided on an outer side with a corresponding optical channel (401) corresponding to the corresponding optical transceiver port (101) and a corresponding interface port (402) electrically connected to the corresponding electrical transceiver port (102), to form a corresponding optoelectronic pluggable module (B1); and the optical fiber cable (C) having two ends plugged into the optical channel (41) of the optoelectronic pluggable module (A1) and the corresponding optical channel (401) of the corresponding optoelectronic pluggable module (B1), so as to form the optical fiber transceiver module (D); the interface port (42) being electrically connected to one of a transmission end device and a receiving end device, and the corresponding interface port (402) being electrically connected to another one of the transmission end device and the receiving end device.

17. The optical fiber transceiver module as claimed in claim 14, further comprising an electro-optical conversion driver (34) provided between the electro-optical conversion elements (32) and the electrical transceiver port (12), a photoelectric conversion receiver (33) provided between the optical-electrical conversion elements (31) and the electrical transceiver port (12), a corresponding electro-optical conversion driver (304) the same as the electro-optical conversion driver (34) provided between the corresponding electro-optical conversion elements (302) and the corresponding electrical transceiver port (102), and a corresponding photoelectric conversion receiver (303) the same as the photoelectric conversion receiver (33) provided between the corresponding optical-electrical conversion elements (301) and the corresponding electrical transceiver port (102).

18. The optical fiber transceiver module as claimed in claim 15, further comprising an electro-optical conversion driver (34) provided between the electro-optical conversion elements (32) and the electrical transceiver port (12), a photoelectric conversion receiver (33) provided between the optical-electrical conversion elements (31) and the electrical transceiver port (12), a corresponding electro-optical conversion driver (304) the same as the electro-optical conversion driver (34) provided between the corresponding electro-optical conversion elements (302) and the corresponding electrical transceiver port (102), and a corresponding photoelectric conversion receiver (303) the same as the photoelectric conversion receiver (33) provided between the corresponding optical-electrical conversion elements (301) and the corresponding electrical transceiver port (102).

19. The optical fiber transceiver module as claimed in claim 16, further comprising an electro-optical conversion driver (34) provided between the electro-optical conversion elements (32) and the electrical transceiver port (12), a photoelectric conversion receiver (33) provided between the optical-electrical conversion elements (31) and the electrical transceiver port (12), a corresponding electro-optical conversion driver (304) the same as the electro-optical conversion driver (34) provided between the corresponding electro-optical conversion elements (302) and the corresponding electrical transceiver port (102), and a corresponding photoelectric conversion receiver (303) the same as the photoelectric conversion receiver (33) provided between the corresponding optical-electrical conversion elements (301) and the corresponding electrical transceiver port (102).

20. The optical fiber transceiver module as claimed in claim 14, wherein at least one of the optical-electrical conversion elements (31) and the corresponding optical-electrical conversion elements (301) is an optical diode, and at least one of the electro-optical conversion elements (32) and the corresponding electro-optical conversion elements (302) is a laser diode.

21. The optical fiber transceiver module as claimed in claim 15, wherein at least one of the optical-electrical conversion elements (31) and the corresponding optical-electrical conversion elements (301) is an optical diode, and at least one of the electro-optical conversion elements (32) and the corresponding electro-optical conversion elements (302) is a laser diode.
